(19) United States
(12) Patent Application Publication
(10) Pub. No.: US 2011/0264489 A1
(43) Pub. Date: Oct. 27, 2011

(54) DUAL-CURRENCY ECONOMY FOR A VIRTUAL SOCIAL ENVIRONMENT

(75) Inventors: Joseph Benjamin Ganetakos, Toronto (CA); Felix Leung, Toronto (CA); Karl Joseph Borst, Woodbridge (CA)

(73) Assignee: GANZ, Woodbridge (CA)

(21) Appl. No.: 13/091,858

(22) Filed: Apr. 21, 2011

Related U.S. Application Data
(60) Provisional application No. 61/327,230, filed on Apr. 23, 2010.

(51) Int. Cl. G06Q 99/00; G06Q 30/00

(52) U.S. Cl. 705/12; 705/26.8

(57) ABSTRACT

A system is provided in which at least two different types of currencies exist in an economy established for a virtual environment. A first currency is earned or obtained by a participant through activities performed while in the environment, and it is used to pay for activity fees and to purchase personal use items including but not limited to food, clothing, home furnishings, house pets, and event tickets. A second currency is limited in its use and is more difficult to obtain. The second currency is used to purchase infrastructure items for a particular town in the environment (e.g., new buildings, villager homes, or upgrades to existing properties). These two currencies are not interchangeable and items/property purchased by village contributions cannot be transferred between villagers.

### CROSS-REFERENCE TO RELATED APPLICATION

This application claims the benefit of U.S. Provisional Application No. 61/327,230, entitled ECONOMY FOR AN ONLINE SOCIAL OR GAME ENVIRONMENT and filed on Apr. 23, 2010, the entirety of which is incorporated herein by reference.

### FIELD OF THE INVENTION

This application relates generally to computer-based social environments. More specifically, this application relates to an economic system and method in which two types of currencies are provided. This dual currency economic system facilitates progression through the game, social interaction, group play and cooperation among multiple users within a virtual environment.

### BACKGROUND

Once primarily used for research and shopping, the Internet has quickly become an alternative source for entertainment, dating, and multi-player gaming. Through various types of websites, virtual communities have been established that allow users to create a virtual or online reality for themselves. Computer games have also crossed over into the online world, allowing users to play against or along with each other from the comfort of their own homes, Internet cafes or other Wi-Fi outlets around the world. When it comes to most online entertainment activities including gaming and virtual communities, a disconnection unfortunately exists between objects in the real world and objects in the online world.

More recently, however, entertainment websites have been developed in which the website content is directly tied to a product that is purchased by a user. For example, as disclosed in U.S. Pat. No. 7,534,157 to Ganz, incorporated herein by reference, a user purchases a toy that includes a secret code provided in the toy packaging. Access to a certain interactive content on the website provided by the manufacturer of the toy is restricted to users who purchase a toy. When the user carries out a registration process on the manufacturer's website, which involves entering the secret code, a virtual world is presented to the user. The virtual world includes a virtual toy corresponding to the toy purchased by the user. The user can participate in various interactive activities involving the virtual toy. The user may then purchase additional toys and enter the secret codes provided with those toys to add additional virtual toys to the virtual world. These virtual toys can interact with each other, thereby enhancing the user's entertainment experiences. Despite the popularity of such websites, consumers continue to demand more interactive capabilities and more flexibility with respect to their virtual products.

### SUMMARY

The subject application involves a system and/or method which facilitate creating and maintaining a dual currency based economy for a virtual social or gaming environment. As discussed in further detail below, a first currency is earned or obtained by a participant in a virtual world (e.g., game or social environment) through activities performed while in the environment including but not limited to playing games, attending or participating in events, selling items in a marketplace, finding treats or bonuses, performing designated (e.g., daily) activities, and the like. Similarly, the first currency is also used to purchase personal use items including but not limited to food, clothing, home furnishings (e.g., those that are not attached to the building), house pets, activity participation fees, and event tickets.

A second currency (e.g., communal currency) is limited in its use and is more difficult to obtain. That is, the second currency is used to purchase major home improvements (e.g., windows, roof, flooring, expansions), which can aesthetically benefit the community, and communal use items such as infrastructure items for a particular town in the virtual environment (e.g., a town's school building or post office or specialty food store). In addition, there are fewer opportunities to obtain the second currency. Primarily, the second currency is earned according to the number of villagers registered to a user account. An amount of the second currency is given at registration of each villager figurine. In addition, each day a user logs into the environment, another amount of the second currency is deposited for each villager the user has registered.

According to one aspect, a computer system for purchasing virtual items in a virtual environment is provided, which comprises an earned currency detection component of a computer system that associates a user account with a plurality of currency accounts including: a first currency account storing a quantity of a first virtual currency in a storage device associated with the computer system, wherein the first virtual currency may be used only for making purchases of a first type, and a second currency account storing a quantity of a second virtual currency in the storage device associated with the computer system, wherein the second virtual currency may be used only for making purchases of a second type, where the second type is different than the first type, and where said first virtual currency cannot be used for making purchases of said second type, and where said second virtual currency cannot be used for making purchases of said first type.

With respect to another aspect, a computer system for voting for making communal purchases in a virtual community. The system includes a communal account stored in a storage device associated with a computer system, wherein the communal account is associated with a particular community having a plurality of member users, and wherein a quantity of currency stored in the communal account includes at least one donation of currency from at least one of said plurality of member users; and a voting system that initiates a vote on whether to proceed with a proposed purchase of a designated virtual item using a quantity of currency stored in the communal account, wherein the vote is initiated at the request of one of said plurality of member users.

According to yet another aspect, a computer system for purchasing virtual items in a virtual environment. The system includes a computer system that associates a user account with a plurality of currency accounts including at least a first currency account storing a quantity of a first virtual currency in a storage device associated with the computer system, wherein the first virtual currency is used only for making purchases of a first type, and a second currency count storing a quantity of a second virtual currency in the storage device associated with the computer system, wherein the second virtual currency is used only for making purchases of a second type, where the second type is different than the first type, and where said first virtual currency cannot be used for making purchases of said second type, and where said second virtual currency cannot be used for making purchases of said first type, and where a perceived value of said purchases with said first virtual currency is less than a perceived value of said purchases with said second virtual currency.

### BRIEF DESCRIPTION OF THE DRAWINGS

FIG. 1 is a block diagram of an exemplary dual currency economy system which facilitates developing a cooperative social virtual environment.

FIG. 2 is a block diagram of an exemplary economic system that involves the use of a voting system in order to facilitate the use of a second currency that is limited in part to communal purchases in accordance with an embodiment of the subject application.

FIGS. 3-8 are schematic illustrations of at least one aspect of the system of FIGS. 1 and 2 in accordance with various embodiments of the subject application.

### DETAILED DESCRIPTION

Described herein is a system that facilitates creating and maintaining an economy for a virtual social or game environment. The features described herein are intended to be used in a virtual world. Commercial transactions and exchanges as well as the flow or movement of currency and objects are discussed below. The different in-game currencies are discussed in-depth, including the differences between the currencies, how the different currencies are earned and how they are spent. One particular aspect to creating and maintaining the economy involves a communal type of currency (hereinafter “communal currency”). One aspect of communal currency is that it can be used by a player to purchase a villager's personal home or exterior upgrades or improvements to that home, which aesthetically benefits the community. Another aspect of communal currency is that it is contributed by members of the community and then used to purchase a community item that presumably improves the community as a whole. Contrast a community item with a personal use item (e.g., one's furniture or groceries), in which the personal use item provides a benefit only to the purchaser or recipient of the item and has no effect on the community including other users and their villagers residing in the village.

For example, communal currency can be used to purchase a community building, structure, or land (e.g., park or other outdoor space) that is owned by the community and is not controlled or managed by a single individual. Voting is employed to purchase and/or modify the communal object. Depending on the parameters, a decision may be carried by a simple majority, ⅔ majority or by a unanimous vote.

Communal currency use for a communal purchase can be raised by donation and/or by taxes and/or by other fundraising events or activities. Unlike a user's or player's individually-owned possessions, communal objects are tied to the community (e.g., a village or town). Therefore, if a community is dissolved, the communal objects are lost. In some cases, they are not transferrable and the funds cannot be recouped via sale or other transfer of the communal object. However, communal objects can provide benefits to the community such as by increasing a tourism rating of the village and attracting more visitors, which can benefit individual players, for example by providing an increased market for goods offered for sale by the players. As described in copending application Ser. No. 13/091,756 entitled SEARCH AND NAVIGATIONAL RATING SYSTEM FOR ONLINE SOCIAL ENVIRONMENT (attorney docket GANZ-46584US1) and incorporated by reference herein in its entirety, tourism ratings are values assigned by the system to each village, which are displayed to other players through a search system that enables the players to find new villages to visit. In addition, the player's home may increase in value as a result of a communal object. For instance, a community pool may make the village more appealing to other potential residents thinking of living there or to tourists considering places to visit. In other cases, communities may be able to merge, and thus communal objects can survive the merger. Various other aspects of the system and method for creating and maintaining the economy of a virtual social or game environment are provided below.

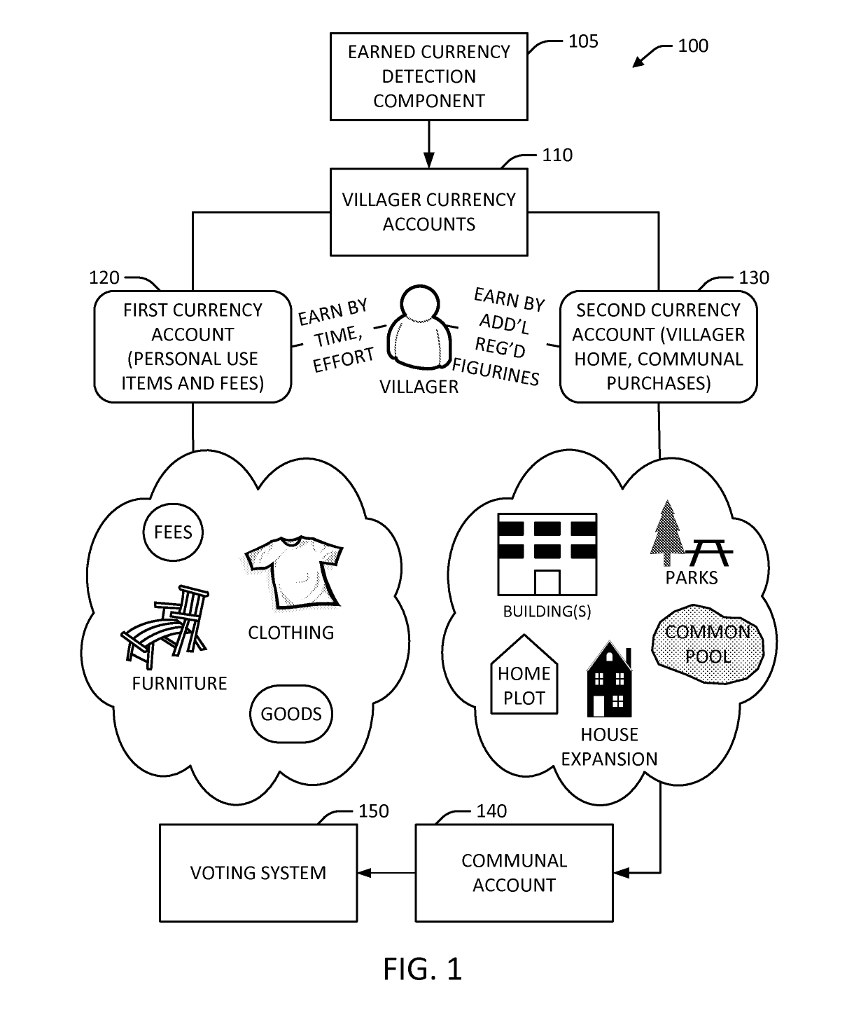

Referring now to FIG. 1, there is illustrated a schematic diagram of an exemplary economic system 100. The system includes an earned currency detection component 105 and villager currency accounts 110. As virtual currency is earned by the villager, the detection component 105 communicates with the villager's currency account to update the proper account with the earned amount. The villager currency accounts 110 comprise a first currency account 120 and a second currency account 130, wherein the first and second currencies represent two different types of virtual (in-game) currency that are used in the virtual environment. The two types of currencies differ in the manner and ease with which they are earned or obtained and in the manner with which they may be spent.

The first currency (e.g., Woodsies or Acorns) is primarily used to purchase goods for a user's virtual characters or villagers (a user/player can own and control one or more villagers). These types of goods are locked to the user's account and no other user/player can freely use or consume them. Some examples of goods include but are not limited to the following:
Clothing—clothing and accessory items wearable by villagers;
Furniture—used to furnish the interiors of villager houses and village buildings;
Village Building Themes: Village Buildings can have a “theme” applied to the inside, which is a set of cosmetic changes in a package;
Signed (finalized) crafted items available in a store; and
All other goods—other goods such as food, toys, novelty items, outdoor items for a villager's home, event tickets and the like.

The first currency is also used to pay for most in-game “fee” charges incurred by a villager. Such fees include but are not limited to the following:
villager energy: purchased to maintain the villager's energy level;
service fees:
   mailing fee—fees for using our mail system to send messages and/or parcels to other villagers;
crafting fees:
   tailoring fee—a fee for changing the tailoring elements of craftable clothing.
   crafting fee—if a villager does not reside in a village or doesn't otherwise have access to a crafting building, the villager can bring her materials to a designated crafting location and pay a fee to craft items.
advertising/sales fees:
   market stand rental (tiered/variable)—purchase a stand for a limited time to sell villager's items in an open market—different stands have different costs as some have better exposure than others.
   sales board ad (basic)—a fee for villagers to post ads on the sales board, to advertise items they wish to sell.
   auction house fee—a fee for listing goods for auction in the auction house.
capacity upgrades (basic):
   crafting building vended storage upgrade—an upgrade to increase the storage capacity of vended materials in a specific crafting building (the crafting building is where a villager places his crafting materials up for sale for others to purchase). The cost of these upgrades is exponential; the more a user increases the capacity, the more it costs, but the cost is below that of a new building.
donation—a villager's town may request a donation or there may be other charitable causes that the villager can contribute to.

Generally, the accumulation of the first currency is relative to how much time and effort the villager spends on the site participating in activities, etc. within the environment. Anything purchased with (or sold for) the first currency can be traded or sold to another villager or can be sold back to the system (at a fraction of its value).

The second currency (e.g., communal currency) is the in-game currency used to improve the aesthetics of a village or to further develop the village (e.g., to grow or expand it) for the benefit of the resident villagers. This includes purchasing buildings, building exterior upgrades (paint, doors, windows, new roofs, new landscaping), community park benches, community swimming pool or recreation center, street lighting, building expansions, buying more land for parks or additional buildings, etc. Some buildings can also be for personal villager use, in which case, the voting system as described herein may not be needed since other villagers are not contributing to the cost. Similarly, building upgrades can be applied to community use buildings (e.g., stores, libraries, etc) as well as villager homes. When applied to personal homes, the voting system may also not be necessary; however, if a village has rules on exterior paint color, then the villager may be limited to a village-prescribed palette of exterior paint colors. New additions to a villager's home such as expansions or new pool or spa may also not require a vote because it is the villager's own second currency that is used to make the purchase.

Generally, the accumulation of the second currency is relative to how many villagers a user has purchased (e.g., using real currency). With each new villager acquired, a designated amount of the second currency is given to that new villager's second currency account 130. The second currency is not interchangeable with the first currency. That is, the second currency cannot be used to purchase any of the goods listed above that is purchased using the first currency and vice versa. Furthermore, the first currency cannot be exchanged for an amount of the second currency and vice versa.

Anything that is purchased with the second currency cannot be sold or traded to another villager. Also, the second currency itself cannot be transferred to another player. However, it is possible for village property (purchased using the second currency) to be sold back to the system (at a fraction of its value). The proceeds from such a sale can be re-distributed to the village's villagers or to those who contributed to the purchase of the property.

The second currency is earned or obtained in smaller amounts and less frequently in comparison to the first currency. As a result, villagers (at least two) need to combine their second currencies or portions thereof, in order to make “communal” purchases such as one of the following:
Buildings: these are buildings that a villager can purchase for his village. Generally, there is some kind of functionality in these buildings (a store, activity, a house for a villager to live in, etc). There may be add-on upgrades for specific buildings (like a crafting station, and extra activities).
Village improvements: objects that are used to decorate the town, such as benches, lamp-posts, etc. This also includes outdoor “furniture” such as lawn ornaments, outdoor ponds, etc.
Upgrades: these are exterior upgrades to buildings, such as nicer windows, a different roof, etc.
House expansions: villager houses have the option to add a tier (size upgrade) to increase the interior space of the house.
Wonders: similar to marvels but bought and managed by villagers through a voting system. Wonders represent the most lavish and desirable buildings, structures, and natural features that players can acquire. A towering, Kilimanjaro-like mountain, an awe-inspiring great pyramid, a dazzling waterfall—these are all examples of wonders. Wonders themselves can be extremely expensive; villagers first work to unlock the ability to buy wonders. Villagers must upgrade their town hall (center community structure of town/village) to a certain level to access wonders. Once the villagers have passed this level, the “wonders wing” of the town hall is opened. Wonders can only be acquired collaboratively. To purchase and place a wonder in a collaborative or public village, the player must complete a petition and voting process. Wonders are owned by the village; no one player can claim ownership of a wonder. Any editing of a wonder's placement or facing in a village requires a petition and voting process. Wonders are bound to the village they are purchased in. Should the village dissolve, the wonder can be destroyed and the money spent on it might be lost. Purchasing a wonder is a one-way purchase; once the money is spent, there is no way to resell a wonder or recoup expenses. Wonders can only be placed in a public plot that has sufficient room. Under no circumstances can wonders be placed in a private plot. Villagers can be required to vote in order to move or re-orient a wonder.
Marvels: structures or village features that are extremely expensive. It is possible these buildings are like achievements, in that even if a user sells her account they are not sold with it. Though wonders are multiplayer-only items, marvels are essentially a single-player equivalent to wonders. Marvels are extremely expensive buildings and structures that are available to players individually; they are similar to wonders in concept, though are considerably smaller in size, scope, and price. They also follow the same inventory and handling rules as normal buildings. Marvels also have a small effect on tourism rating. Marvels are purchased from the same “wonders and marvels NPC” (non-player character) in the “wonders wing” of the town hall that is only accessible after a player has upgraded to a certain level. Only players who have passed this milestone can have access to this vendor and be able to purchase marvels. Unlike wonders, marvels may not have tiers. Once a player has unlocked the ability to purchase marvels, she can purchase any of the marvels available in the game. Marvels can, however, vary in price based on functionality and desirability. Marvels may not have a pre-defined price range. Unlike wonders, marvels are items bound to a specific individual, and therefore, they are treated identically to buildings a villager owns; they are placed in the village in the same way, and follow the same inventory rules. When a villager moves out and leaves a village, she takes her marvels with her.
Building functionality addition: the villager can purchase optional functionality upgrades for specific village buildings. For example, some buildings may have an optional crafting function which can allow a player to craft her items in her building or it may be possible to purchase additional activities (games) for a building.
Village Registration fee: to start a village, and different types of villages (solo/public/private) cost different amounts.
Activating a new plot: Unlocking a new plot in a villager's current village allows him to continue building on land in his village.

Villager contributions of the second currency to make a ‘communal’ type of purchase are made to a communal account 140 which can be established for each village. When sufficient funds for a proposed village purchase are collected in the communal account 140 associated with the village, a voting system 150 can be triggered in order to obtain approval of the village purchase using the communal account 140 funds. Alternatively, the voting system 150 can be triggered by at least one villager (or at least two villagers) before donations or contributions are sought from the villagers to complete a village purchase. The remaining figures discuss the voting system 150 in greater detail.

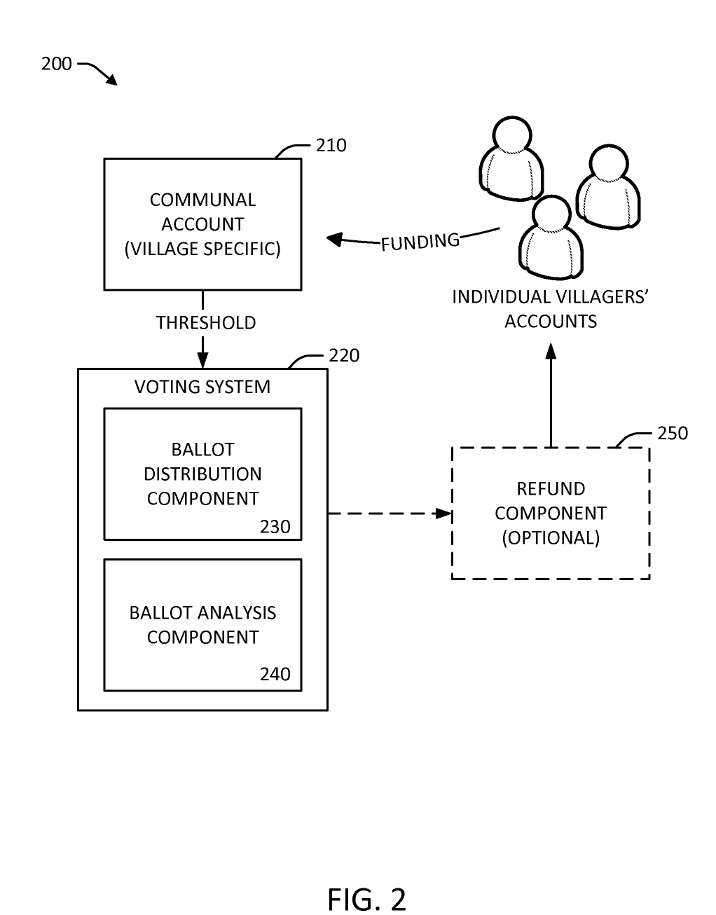

FIG. 2 demonstrates an exemplary economic system 200 which a village can initiate in order to purchase a new village property. The system 200 includes a communal currency storage 210 (e.g., communal bank account) which is established for each village. Villagers contribute to the communal currency storage 210 as they desire. They may also make contributions to the communal account 210 if they want to donate to a specific project (e.g., proposed or approved village acquisition). In one embodiment, a voting system 220 is triggered once a threshold amount of communal currency has been accumulated in the account 210. For example, once X amount of communal currency is reached in the account 210, the voting system 220 alerts the villagers that sufficient funds exist in the account 220 to purchase item G. The voting system 220 distributes ballots via a ballot distribution component 230 to each villager (who resides in the village). A ballot analysis component 240 counts the ballots that are received within the designated time frame.

In the alternative, a villager (or at least 2 villagers) can identify a village acquisition that they would like to make along with the cost of such acquisition. Following that, the voting system 220 can request each villager to vote on that purchase. If the vote is in favor of the indicated purchase, then an optional time period can be set in order to raise communal currency in the communal account 210 to complete the approved purchase.

In either option, if there are insufficient funds raised or if the vote is against the purchase, then any communal currency raised for a particular purchase can either remain in communal account 210 or can be refunded to those villagers who contributed via a refund component 250.

The existence of communal currency and the voting system as described above facilitate a community managed village as opposed to a village dominated by one or a by a minority of villagers. Village purchases using the second currency (communal currency) remain with the village. Therefore, if a contributing villager later moves out of a village, they have lost any ownership value in the village purchase. If the village dissolves, the village purchases may also be forfeited or they may be sold back to the system for at least a fraction of the cost. Any communal currency earned from such sales is either redistributed to those villagers who contributed and still reside in the village or to all of the current villagers residing in the village at the time of the sale.

The voting system 220 also is programmable to limit the length of a vote (duration that a vote is open) as well as the frequency of vote requests for the same subject. Though not pictured in FIG. 2, the voting system 220 can also include a vote request tracking component, which would keep track when votes are initiated and the corresponding subjects of each vote. This is primarily for subjects which previously lost their votes as a successful vote does not need to be re-initiated by the requesting villager. This tracking component verifies that a pre-determined amount of time has passed since the last vote for the same subject (and/or by the same villager) before another vote request on the same subject can be re-initiated. If not enough time has passed, then the villager may receive a message indicating when to return to request the vote or when such a vote can be re-initiated.

Regarding the length or duration that a vote is open, the system-selected duration depends on the subject of the vote. For example, if the vote is to add a new building, the vote may be open longer than a vote to add street decorations. Alternatively, the duration of each vote may be the same regardless of the subject.

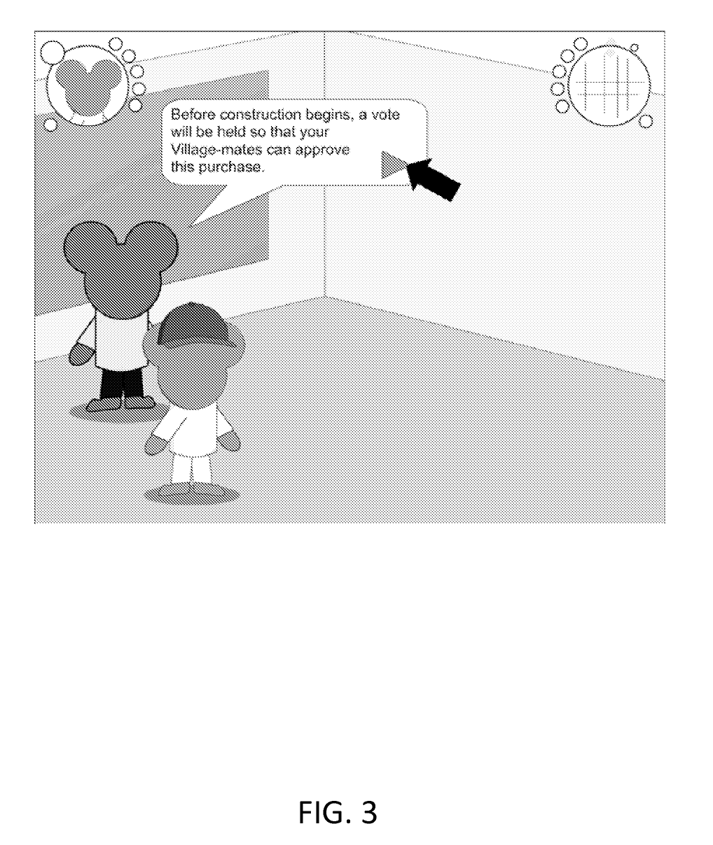

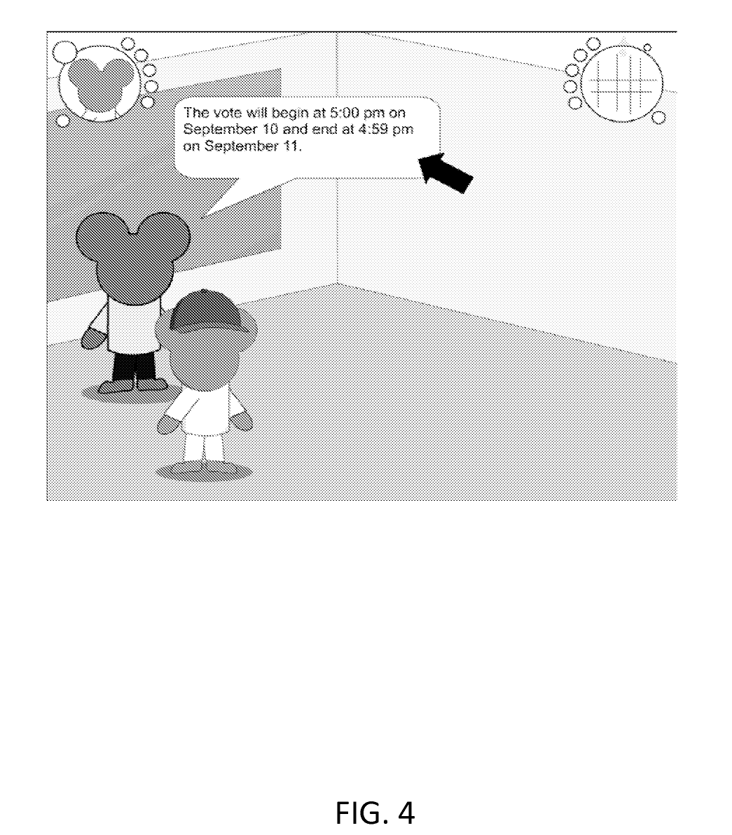

FIGS. 3-7 demonstrate an exemplary implementation of communal currency in connection with a voting system. In particular, imagine that a villager wants to “construct” a Great Pyramid attraction in his village to boost tourism. When a villager makes a request for this kind of change to the village, a vote of the village's villagers is held as demonstrated in FIG. 3. A voting system such as discussed in FIGS. 1 and 2 arranges and presents a vote to the villagers by way of a vote announcement. An exemplary vote announcement is illustrated in FIG. 4. The vote announcement includes the start and end time of the vote.

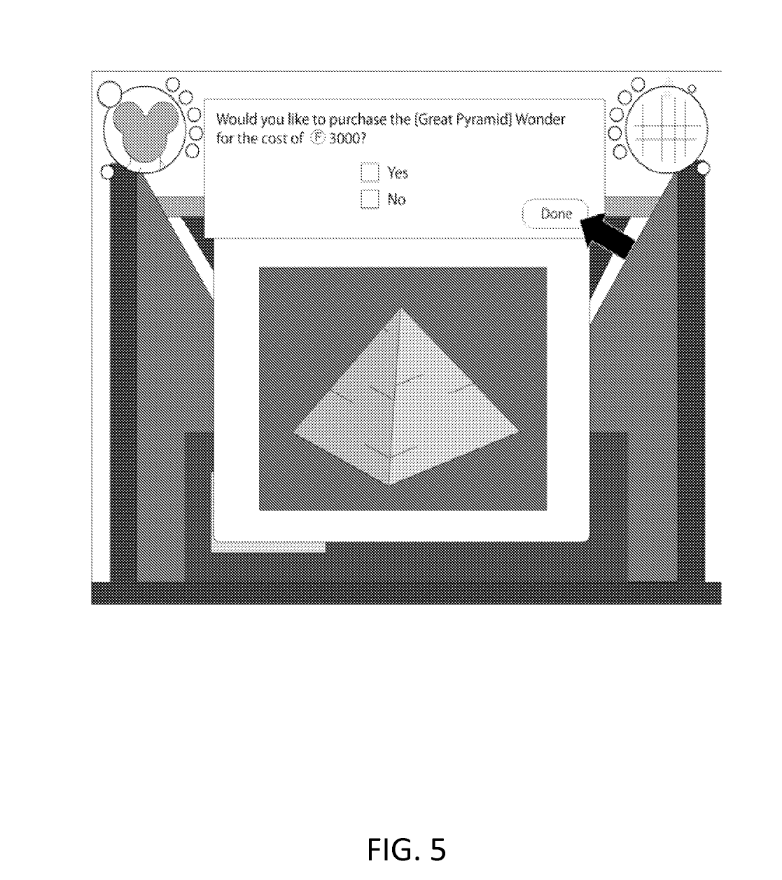

Villagers can keep a vote private within the village or can post it to a message board that is viewable by the public (e.g., other villages' villagers or tourists). For this particular construction request, each affected villager receives a ballot such as the one depicted in FIG. 5 that asks them to vote “yes” or “no” on whether they wish to purchase the Great Pyramid property. If the property acquisition request does not pass, for example by a majority of “yes” votes, the Great Pyramid's placeholder in the village will be discarded, and the process will end.

On the contrary, if a majority vote is obtained for instance (e.g., some changes may require ⅔ majority), the footprint of the Great Pyramid is filled with a construction site, which marks the beginning of the fund-raising phases. Conversely, in another embodiment, the fundraising is done prior to putting the acquisition request to a vote.

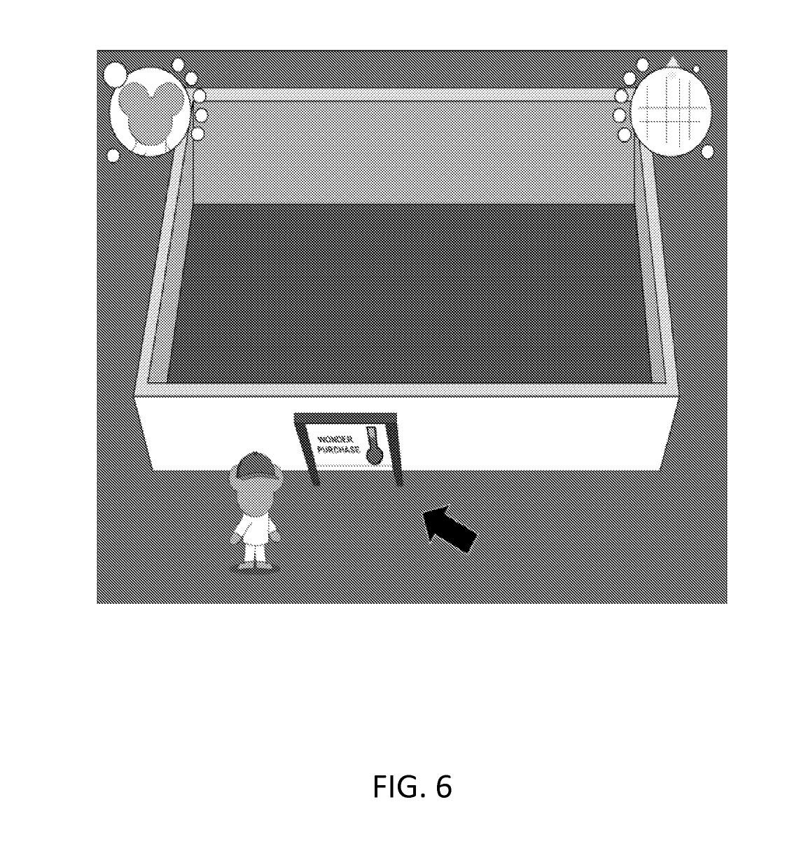

As shown in FIG. 6, the construction site, which is the core of the fundraising phase, is a temporary placeholder structure that will occupy the space the Great Pyramid (or other property) will eventually sit in. This area of the virtual environment hosts the property's fund-raising.

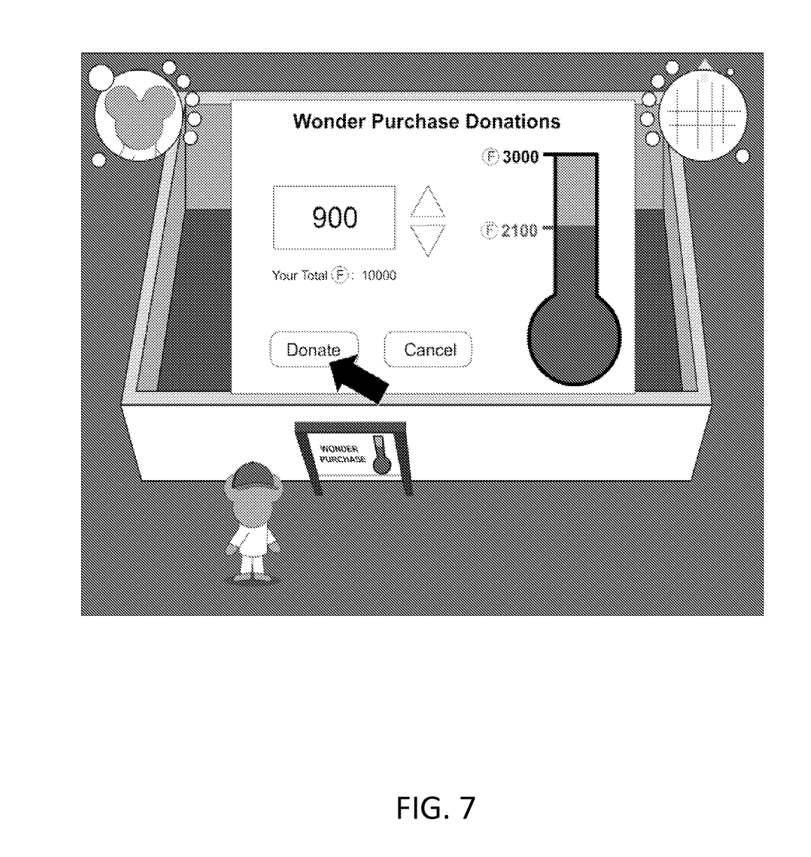

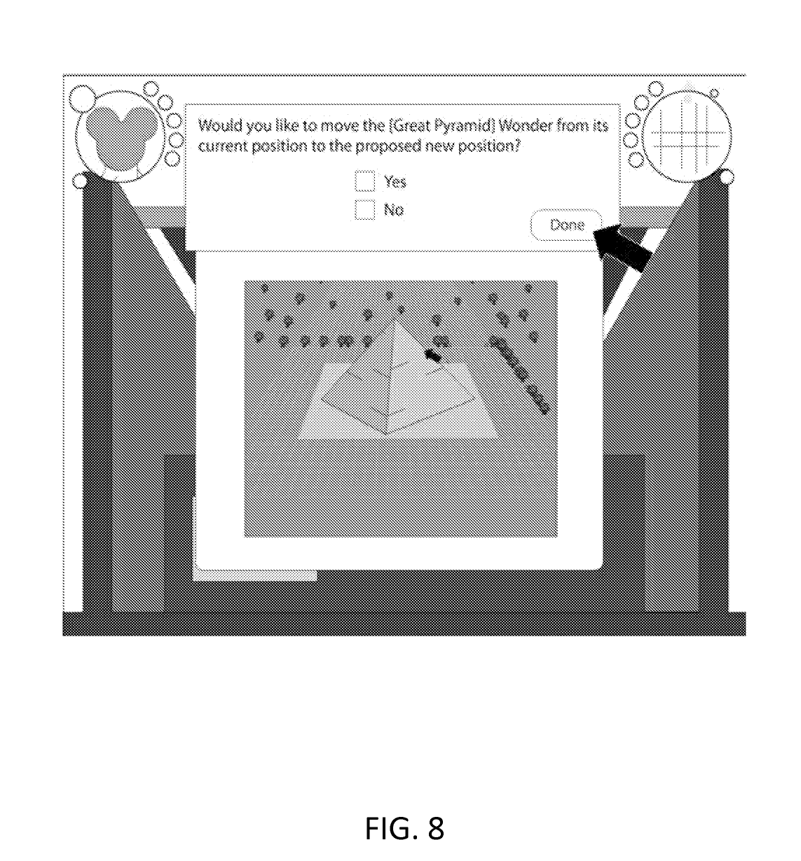

FIG. 7 illustrates the donation status in connection with the property's construction site. Villagers are required to donate money to the construction site in order to actually pay for the property selected. The construction site also has a “Donation Board.” Villagers interact with this board in order to donate money towards the total cost of the desired property (e.g., Great Pyramid).

According to one embodiment, no money (e.g., second currency) is taken from any donating members of the village until a majority vote is determined. Visually, the amount of second currency would be shown as being temporarily allocated to an identified vote (e.g., “the Great Pyramid vote”) to make it clear to the user that those monies are not available to be used elsewhere until the vote is decided. Alternatively, the amount of second currency being donated for a particular vote can be withdrawn from the villager's account and moved to the village's communal account when the villager casts his vote in favor of the expenditure. If the vote does not pass, then that money can be refunded.

When the total has been reached, the selected property will appear after a brief animation of construction work. The property has now become a new attraction for the village, positively affecting the village's tourism rating and attracting outside visitors. Once a property is constructed, villagers are free to cast another vote in order to move or re-orient it. If sufficient funds are not raised to purchase the property within a predetermined period of time, the collected money can be refunded.

A vote to move a property is initiated by visiting a designated NPC in the village (e.g., at the village's Town Hall). The player who initiates the vote is the player who is permitted to propose a new position using the same user interface used for the initial purchase and positioning. If a new position was successfully selected, the petition phase is set in motion and the player is informed that a new vote is to begin to approve or deny the proposed new location for the property item. As with the process of purchasing a selected property item, players will enter a petition phase. A vote will be put to all the members of a village consistent with a set of published voting rules posted on an information board or elsewhere in the village. There may also be a link to the rules included in the vote announcement. When players go to vote on the new position, they will be shown a preview of how the building will look in its new position on the village grid. If the vote does not pass, the property item will remain in its current position. If the vote passes, the property will assume its new position.

A third currency which is different from the first and second currencies, as described above, is known as eStore points. This currency is used to purchase premium enrichments that are not necessary to playing or living in the virtual environment, but that a villager or player may like to further enhance his experience in the virtual environment. This currency is purchasable in point-bundles in the eStore using real currency. The types of premium enrichments purchasable by eStore Points are:
eStore Items: Certain Goods or Buildings may only be purchasable in the eStore (not available in-game for purchase using first or second currencies).
Sales Board Ad (Premium): Players can post ads on the sales board to advertise items they wish to sell. These ads have precedence (have higher priority) over Basic Ads.
Personal Inventory Upgrade (Premium): An upgrade to increase a villager's carrying capacity for small or large items. The cost of these upgrades is exponential; for example to upgrade to carry 20 more items costs more than upgrading to carry 15 more items. These capacity upgrades are better than the best low-level Personal Inventory Upgrade.

Because object collection is such a large part of this game, the game economy (consisting of the first and second in-game currencies and what is bought with those currencies) needs to remains stable so currencies and objects always maintain their value. As part of maintaining a successful virtual economy in the environment, items which are available for purchase or trade should have and be able to maintain their perceived value relative to their worth. The perceived value is from the perspective of the player and is a combination of the effort used to attain the object (if applicable), the item's base value (the cost of the object if purchased at a system-owned store), and the item's rarity. Calculations and valuations to determine an item's cost whether it be an item purchasable using first currency or second currency, how much first currency to reward for activity participation or completion, to select an item which will be given as a reward for activity participation or completion (e.g., “a drop”) are determined with that in mind—to maintain an object's perceived value and to maintain the desired balance between perceived value of an item or property and villager effort needed to obtain it.

The relative scale of perceived value between objects should not change. In the following example, X, Y and Z each represent a large amount of effort: If one worked X hours for object A, X+Y hours for object B, and X+Y+Z hours for object C:
Object A has a high perceived value.
Object B has a higher perceived value than object A. Object C has a higher perceived value than object B.
Over time, the player can gain more objects with a higher perceived value than those mentioned above. But the order of perceived value is maintained for previous objects (C>B>A). And object A always has a high perceived value (something one worked hard for before should not feel worthless later).
The above example can be reused for object Rarity or Base Value, instead of effort.

One benefit of having a currency system as in the present embodiments, in which the first currency is exclusively used to purchase goods and other personal items and the second separate currency is used to purchase larger, infrastructure-type items is the added stability to the game economy while maintaining intact the concept of perceived value. For example, many personal goods, such as clothing and furniture may be available in limited quantities, especially those that are individually crafted and signed. At the same time, infrastructure-type items, such as buildings, should be perceived as being much more expensive than goods in order to create a realistic environment. However, it is desirable to allow villagers to build attractive villages in a reasonable amount of time, so the players must be able to obtain enough currency to buy infrastructure-type items. If the same currency were used to purchase goods and infrastructure, some villagers might choose to corner the market on particular goods by purchasing them in excessive quantities instead of using the currency to purchase infrastructure-type items. By splitting the currencies and allowing villagers only to purchase goods and personal items with the first currency and to purchase infrastructure-type items with the second currency, both goals can be achieved: players are prevented from skewing the market for goods while still having enough currency to purchase infrastructure items within a reasonable amount of time.

The perceived value of what the currencies buy is completely different, for example, as a function of what it takes to obtain the currencies. For example, the user may work a similar amount of time or effort to get one unit of each currency. However, one unit of one currency might buy 1/100th of a shirt, while the same one unit of the other currency buys 1/100th of a convention center. The perceived values in the real world would be completely different. For example, according to this embodiment, the other currency may purchase items which if purchased in the real world would be at least 1000 times more than the items purchased by the first currency. Hence, the perceived value of the second currency may be at least 1000 times more than the perceived value of the first currency. However, it may take similar amounts of work and/or activity in the virtual world to obtain these two items.

In another embodiment, while it may take similar amounts of time to obtain one unit of currency 1 as it takes to obtain one unit of currency 2, different kinds of work may be necessary to obtain currency 1 than is necessary to obtain currency 2, even though the perceived values of what one unit of currency 1 would purchase, if in the real world, would be completely different than what one unit of currency 2 would purchase.

Furthermore, the second currency is more stable than the first currency because it is earned primarily by the number of villagers registered to the user's account and is independent on the effort expended through participation of activities and success in those activities.

Gaining in-game currency is a reward for a combination of the below: effort with respect to the time the player spends influencing currency growth; payment in terms for the number of villagers a user owns; and loyalty with respect to the time (chronological) spent on the site and logging in on a regular basis. The accretion of the first currency in the virtual environment is a function of (in order of importance) mainly effort and to a lesser extent, payment, whereas the accretion of second currency is a function of (in order of importance) payment, loyalty, and effort. The first currency as well as other personal items owned by a villager is transferable to other player (user) accounts.

There are a number of ways to earn first currency in the subject virtual environment. Some examples include participating and completing play activities or mini-games. The amount of first currency is based on the length of the activity and the villager's performance.

Generating second currency is accomplished in a different manner. A villager who starts a village (e.g., founding villager) receives a donation from each of the village's villagers to his account on a timed basis (e.g., every day or each time a user's villager logs in). The founding villager (e.g., its user) may not need to be logged in to receive the donation. Alternatively, the player needs to log in regularly, or donations will begin to decrease. The participation in or completion of certain activities can also result in the rewarding of second currency.

Though not pictured in FIGS. 1-2, the system 100 or 200, for example, also includes a registration component that registers a physical product using a distinct code which identifies the type or name of the physical product. A real user is associated with the physical product through the registration process in which the product is essentially registered in the user's account. As a result of the registration, a virtual representation of the physical product appears on-screen in the virtual environment and the user interacts within the environment through her product's virtual representation, for example as a villager resembling the physical product, such as a figurine in the form of an imaginary or real animal or person. The user controls the actions and behavior of the virtual representation of the physical product. If desired, the user can register multiple physical products using the same account and thus control multiple virtual representations in the environment.

Each of the systems of FIGS. 1-2 can be separately integrated into or as a part of a computer system, which is employed to generate the virtual environment to be presented to a remotely-located user operating a computing device. The computer system includes an administrative server for managing a variety of administrative tasks. For example, the administrative server can validate registration information associated with physical products being registered by a user, the administration of user accounts, and other such administrative matters.

A web server can also be included as part of the computer system. The web server can host a website comprising the virtual environment as well as other features that are to appear within the virtual environment. The web server can serve content via a communication network to at least a first computing device (e.g., end-user) as well as a second computing device, each being remotely located from the web server and from each other. The administrative server and the web server can optionally be embodied by a single terminal. The communication network can include a wide area network (“WAN”), a local area network (“LAN”), or a combination thereof. For example, the web server may communicate with the first and second computing devices in a known manner using a TCP/IP protocol over the Internet, which is an illustrative embodiment of the communication network. One or both of the computing devices can optionally be connected to the Internet via an internal gateway, router, switch, and/or any other networking devices employed to achieve the Internet connection. In one embodiment, the web server can produce output over the network as an HTML webpage based on a request.

An exemplary architecture of the computer system, particularly the administrative and web servers that collectively operate to generate the virtual environment is described as follows. A non-transitory computer-readable medium such as a hard disk drive is operable as a storage component for storing data involved in maintaining the virtual environment and other content to be served to the computing devices via the communication network. The storage component may also store computer-executable instructions that, when executed by a computer processing unit, provide for the generation and management of the virtual environment as described above.

The foregoing description includes illustrative embodiments of various aspects of the subject system and/or method. It will be apparent to those skilled in the art that the above systems and methods may incorporate changes and modifications without departing from the general scope of this invention. It is intended to include all such modifications and alterations within the scope of the subject application. Furthermore, to the extent that the term “includes” is used in either the detailed description or the claims, such term is intended to be inclusive in a manner similar to the term “comprising” as interpreted when employed as a transitional word in a claim.

What is claimed is:

1. A computer system for purchasing virtual items in a virtual environment comprising:
an earned currency detection component of a computer system that associates a user account with a plurality of currency accounts including:
a first currency account storing a quantity of a first virtual currency in a storage device associated with the computer system, wherein the first virtual currency may be used only for making purchases of a first type, and
a second currency account storing a quantity of a second virtual currency in the storage device associated with the computer system, wherein the second virtual currency may be used only for making purchases of a second type, where the second type is different than the first type, and where said first virtual currency cannot be used for making purchases of said second type, and where said second virtual currency cannot be used for making purchases of said first type.

2. The computer system of claim 1, wherein said purchases of the first type include at least clothing, furniture, and other virtual goods for use by a virtual character, and wherein said purchases of the second type include at least buildings, outdoor furnishings, other outdoor structures, and plots of virtual land.

3. The computer system of claim 1, wherein said computer system allows purchases of the first type made with said first currency to be resold for first virtual currency to another user account, and wherein said computer system does not allow purchases of the second type made with said second currency from being sold to another user account.

4. The computer system of claim 1, wherein said computer system allows purchases of the first type made with said first currency to be transferable to another user account, and wherein said purchases of the second type made with said second currency are prevented from being transferred to another user account.

5. The computer system of claim 1, wherein said purchases of the second type are owned by a community with which the user account is associated rather than by an individual user.

6. The computer system of claim 5, wherein said purchases of the second type are purchased with said second currency stored in a communal account associated with the community.

7. The computer system of claim 6, wherein at least part of said second currency stored in said communal account was transferred from said second currency account associated with said user account.

8. The computer system of claim 1, wherein computer system prevents interchanging the first currency and the second currency.

9. The computer system of claim 1, further comprising a communal account storing a second quantity of the second currency in the storage device associated with the computer system, wherein the communal account is associated with a particular community associated with a plurality of user accounts, said user account being one of the plurality of user accounts, and wherein at least part of the second quantity of the second currency is a donation from said user account.

10. A computer system for voting for making communal purchases in a virtual community comprising:
a communal account stored in a storage device associated with a computer system, wherein the communal account is associated with a particular community having a plurality of member users, and wherein a quantity of currency stored in the communal account includes at least one donation of currency from at least one of said plurality of member users; and
a voting system that initiates a vote on whether to proceed with a proposed purchase of a designated virtual item using a quantity of currency stored in the communal account, wherein the vote is initiated at the request of one of said plurality of member users.

11. The computer system of claim 10, further comprising a refund component that refunds said at least one donation of currency if said vote does not pass.

12. The computer system of claim 10, wherein the vote is initiated once the computer system determines that a sufficient quantity of currency to purchase the virtual item is stored in the communal account.

13. The computer system of claim 10, wherein when the vote does not pass, the computer system prevents initiation of another vote on the purchase of the same designated virtual item until after passage of a predetermined period of time.

14. The computer system of claim 10, wherein said virtual item is a virtual structure, wherein said one of the plurality of users who initiates the vote designates a location in a virtual environment associated with said community where the virtual structure will be placed, and wherein the computer system causes a virtual construction site to be displayed at the location until after both a sufficient quantity of currency to purchase the virtual structure is stored in the communal account and the vote passes, after which time the virtual construction site is replaced with the virtual structure.

15. The computer system of claim 14, wherein the virtual construction site includes a mechanism for accepting donations of virtual currency into the communal account.

16. The computer system of claim 1, wherein said purchases of the second type using said second currency are for one of personal use or communal use.

17. The computer system of claim 10, wherein said computer system has a first currency account storing a quantity of a first virtual currency in the storage device associated with the computer system, wherein the first virtual currency may be used only for making purchases of a first type, wherein said communal account is in a second currency account storing a quantity of a second virtual currency in the storage device associated with the computer system, wherein the first virtual currency may be used only for making purchases of a first type, and where the second type is different than the first type, and where said first virtual currency cannot be used for making purchases of said second type, and where said second virtual currency cannot be used for making purchases of said first type.

18. A computer system for purchasing virtual items in a virtual environment comprising:
a computer system that associates a user account with a plurality of currency accounts including at least a first currency account storing a quantity of a first virtual currency in a storage device associated with the computer system, wherein the first virtual currency is used only for making purchases of a first type, and a second currency count storing a quantity of a second virtual currency in the storage device associated with the computer system, wherein the second virtual currency is used only for making purchases of a second type, where the second type is different than the first type, and where said first virtual currency cannot be used for making purchases of said second type, and where said second virtual currency cannot be used for making purchases of said first type,
and where a perceived value of said purchases with said first virtual currency is less than a perceived value of said purchases with said second virtual currency.

19. The computer system as in claim 18, wherein said second virtual currency purchases items, which if purchased in the real world would be much more expensive than the items purchased with said first virtual currency.

20. The computer system as in claim 18, wherein items purchased with said second virtual currency are at least 1000 times more expensive per unit than items purchased with said first virtual currency.
